(19) United States
(12) Patent Application Publication
(10) Pub. No.: US 2016/0227837 A1
(43) Pub. Date: Aug. 11, 2016

(54) DISPOSABLE ELECTRONIC CIGARETTE TANK

(71) Applicant: The Vapor Bar, McKinney, TX (US)

(72) Inventors: Michelle Denise HAMMEL, Katy, TX (US); Jeffrey Scott HAMMEL, Katy, TX (US)

(21) Appl. No.: 15/010,478

(22) Filed: Jan. 29, 2016

Related U.S. Application Data
(60) Provisional application No. 62/112,759, filed on Feb. 6, 2015.

(51) Int. Cl. A24F 47/00; H05B 6/36

(52) U.S. Cl. CPC A24F 47/008; H05B 6/36

(57) ABSTRACT

Techniques are described for using a tank containing consumable and vaporizing elements. A system can include a tank having at least one outer side wall, a top wall, and a bottom wall. The tank can include a consumable fluid reservoir adapted to receive at least a consumable fluid, a heating element extending through at least a portion of the consumable fluid reservoir, and an air chamber extending through at least a portion of the consumable fluid reservoir. The system can also include a mouthpiece adapter and a power connection.

### CROSS REFERENCE TO RELATED APPLICATION

This application is related to and claims the benefit of U.S. Provisional Patent Application Ser. No. 62/112,759, filed Feb. 6, 2015, and entitled “Electronic Cigarette Device with Closed, Disposable Tank and Filtration,” which is hereby incorporated by reference for all purposes.

### TECHNICAL FIELD

The disclosures herein generally relate to personal vaporizers used to simulate smoking. In particular, the disclosures relate to vaporizing consumables, and more particularly relate to a disposable, permanently-sealed consumable tank and apparatus for use therewith.

### BACKGROUND

Vaporizing devices typically include a variety of structural elements defining, in, and around a consumable reservoir retaining the material to be vaporized. Such elements can include heating elements for generating vaporization heat, electrical elements for powering the heating element, inlets and outlets assisting with the movement of liquid, air, or vaporized materials, and others. Vaporizing devices typically require refilling, and in some instances require maintenance or replacement of more than the consumable (e.g., changing of heating elements). Refilling and maintenance can be inconvenient and lead to spilled consumables, consumable contamination outside the consumable tank, and lost or broken components.

### SUMMARY

An embodiment of a system can include a tank having at least one outer side wall, a top wall, and a bottom wall. The tank can include a consumable fluid reservoir adapted to receive at least a consumable fluid, a heating element extending through at least a portion of the consumable fluid reservoir, and an air chamber extending through at least a portion of the consumable fluid reservoir. The system can also include a mouthpiece adapter extending away from the top wall of the tank. The mouthpiece adapter is in fluid communication with the air chamber and configured to couple with a mouthpiece for drawing fluid from the air chamber. The system can also include a power connection extending away from the bottom wall of the tank. The power connection is in electrical communication with at least the heating element and configured to couple with a battery.

In another embodiment, a method of making a disposable consumable container for a vaporizing device includes providing a tank having at least one outer side wall, and a bottom wall. The tank includes at least a consumable fluid reservoir adapted to receive at least a consumable fluid, and the bottom wall has an electrical interface. The method further includes installing at least a heating element and an air chamber through at least a portion of the consumable fluid reservoir. The heating element is in electrical communication with the electrical interface. The method also includes providing at least one consumable fluid in the consumable fluid reservoir and installing a top wall to permanently seal the tank, the top wall having a vapor interface for fluid communication with the air chamber.

These and other embodiments are described in greater detail elsewhere herein.

### BRIEF DESCRIPTION OF THE DRAWINGS

To better understand and appreciate the invention, refer to the following detailed description in connection with the accompanying drawings:

FIG. 1 shows example system using a tank configured to contain a vaporizing consumable;

FIG. 2 shows a cutaway view of example system using a tank configured to contain a vaporizing consumable;

FIG. 3 illustrates an example top section for use with a tank configured to contain a vaporizing consumable;

FIG. 4 illustrates a partial cutaway view of an example tank configured to contain a vaporizing consumable;

FIG. 5 illustrates an example bottom section for use with a tank containing a vaporizing consumable;

FIGS. 6A-E illustrate assembly and disassembly of an example system using a tank configured to contain a vaporizing consumable;

FIG. 7 illustrates operation of an example system using a tank configured to contain a vaporizing consumable;

FIG. 8 illustrates an alternative embodiment of an example system using a tank configured to contain a vaporizing consumable;

FIG. 9 illustrates an example flow chart depicting a methodology for making a tank containing a vaporizable consumable; and

FIG. 10 illustrates an example flow chart depicting a methodology for using a tank containing a vaporizable consumable.

### DETAILED DESCRIPTION

Embodiments of the present disclosure may provide personal vaporizing system that can be used to simulate smoking, which may colloquially be referred to as an electronic cigarette, e-cigarette, e-cig mod-box, or other terms in common use. The disclosure includes a disposable tank that is at least partially filled with a liquid (or other material) to be vaporized. The disposable tank may be provided with filtration and liquid filling capabilities. In some embodiments, the electronic cigarette device may include a closed tank that is intended to be opened only by a manufacturer or designated refilling entity to avoid tampering with the contents of the tank and/or provide a simple-to-use, disposable product. The tank may be sealed to discourage a consumer from filling and/or opening the tank and to prevent inadvertent opening of the tank.

Embodiments of the present disclosure may provide a coil attached to the electronic cigarette device, wherein the coil may or may not be independent to the disposable tank. In some embodiments of the present disclosure, a disposable liquid filled tank may be attached to the atomizer coil to form a seal and allow flow to atomizer for vaporization process or the disposable tank may contain liquid, coil, air chamber and filter and attach to battery device for vaporization.

Embodiments of the present disclosure may provide a chamber that runs through a disposable liquid filled tank and to a mouthpiece to allow easy air flow for inhaling vapor. In embodiments of the present disclosure, prior to inhaling, vapor may pass through a filter that may contain carbon and or another filtration-type device to filter out chemical vapors or additives, including formaldehyde or other irritants.

As used herein, “permanently sealed” means irreversibly closed in lieu of at least partial destruction of the structure. Permanent sealing can be accomplished using various adhesives, welding, monolithic construction, et cetera. Where elements are “removably coupled,” in contrast, they are connected by attachment means which facilitating install or uninstall avoiding destruction or deformation of either component being attached. Similarly, an “interchangeable” element is one which can be easily exchanged for a similar (if not dimensionally, qualitatively, or aesthetically equivalent) element. “Operative coupling” or “communication” (e.g., fluid communication, electrical communication) refers to components working together, even if such components are not in physical contact (though they may be in physical contact). A “consumable fluid” can be any vaporizable fluid, such as the fluids used with electronic cigarettes or for “vaping.” Further, while consumable fluids are discussed herein, nothing precludes the use of consumable solids or other materials capable of being vaporized with systems set forth herein. Where components are described as “extending away from” (or in similar terms), such elements need not necessarily be disposed on one another or attached (e.g., a power connection may extend away from a bottom wall even though it is attached to an intervening bottom section structurally distinct from the bottom wall; or the power connection extending away from a bottom wall may reside on the bottom wall itself in an alternative embodiment).

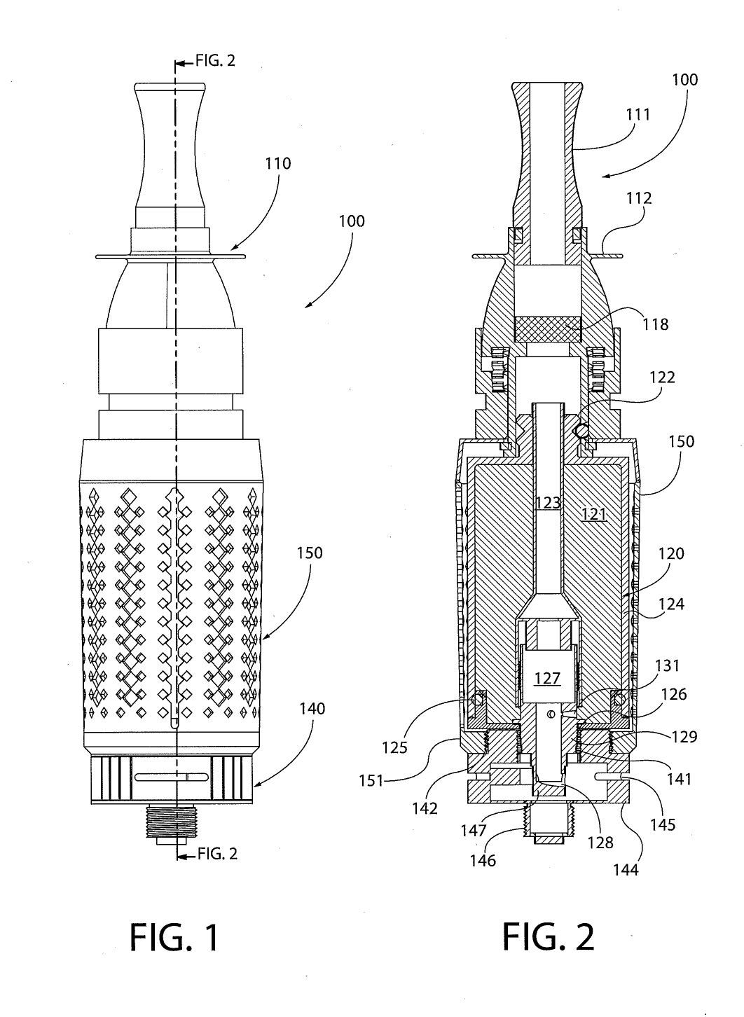

FIGS. 1-7 illustrate an example system 100 disclosed herein used for vaporizing fluids such as water or mixtures of water and various flavors as used to simulate smoking or otherwise facilitate personal vaporizing activity. System 100 includes top section 110, tank section 120, bottom section 140, and cover 150. Tank section 120 may be permanently sealed, disposable, and/or other-wise constructed to limit the tank to a single use.

Tank section 120 can be a disposable, non-refillable tank containing a consumable fluid for use with system 100 in consumable fluid reservoir 121. Tank section 120 comprises a tank 124 can be defined in terms of at least one outer side wall, a top wall disposed toward top section 110, and a bottom wall disposed toward bottom section 140. Tank 124 also includes a heating element 127 or “coil” extending through at least a portion of tank 124 and consumable fluid reservoir 121 which, when provided with electrical power, generates heat in or around the consumable fluid to cause its vaporization. Air chamber 123 also extends through at least a portion of tank 124 and consumable fluid reservoir 121. Air chamber 123 can include a vapor interface 122 disposed toward or beyond the top wall of tank 124. Air chamber 123 can also include consumable inlet 131 located toward heating element 127 and the bottom wall of tank 124 for receiving a consumable fluid from consumable fluid reservoir 121 or vapor produced therefrom. Tank 124 also includes electrical interface 126 disposed toward its bottom wall for providing electrical communication between heating element 127 and power connection 146 (described hereafter). Also disposed toward the bottom wall of tank 124 is air chamber inlet 128 which includes an opening proximate to the bottom of air chamber 123 through which outside air can at least be drawn. In embodiments, o-ring 125 can surround at least a portion of tank 124. As suggested by the structure described above, tank section 120 can in part or in whole define an atomizer, cartomizer, or clearomizer.

Top section 110 operatively couples with tank section 120, establishing fluid communication with air chamber 123. Top section 110 includes mouthpiece adapter 112, which couples with at least vapor interface 122. In some embodiments, mouthpiece adapter 112 is configured to accept interchangeable filter 118. Interchangeable filter 118 can be, but is not limited to, one or more filters that may be used to perform chemical, biological, or mechanical filtration of the fluid drawn through the filter; to restrict or prevent fluid flow; a flow resistance component to change the draw resistance during use; a flavoring component that imbues a flavor as fluid passes through it; a thermal insulating component to cool vapor before inhalation, or other flow control elements. Interchangeable filter 118 can be maintained in filter chamber 119 of mouthpiece adapter 112. To remove or exchange interchangeable filter 118, mouthpiece 111 can be removed and interchangeable filter 118 removed in a direction opposite tank section 120. To ensure interchangeable filter 118 is not inadvertently misplaced within the system, filter chamber 119 is has a bore equal to or greater than the dimensions of interchangeable filter 118, and adjacent portions of mouthpiece 111 and/or mouthpiece adapter 112 in fluid communication therewith (and with air chamber 123) can be bored to smaller dimensions impassable to interchangeable filter 118. In embodiments, no interchangeable filter 118 is included, or an included interchangeable filter 118 can be removed, without impact to the function of system 100.

Mouthpiece adapter 112 extends away from the top wall of tank 124 and couples with mouthpiece 111. Mouthpiece 111 is placed in fluid communication with air chamber 123 through connection with mouthpiece adapter 112 and is configured for drawing fluid from the air chamber.

In embodiments, one or more of the top wall of tank 124, either end of mouthpiece adapter 112, and/or a bottom side of mouthpiece 111 can include a sealing element (e.g., coating, gasket, et cetera) to ensure the surfaces over which these components meet is airtight or substantially fluid impermeable to ensure vapor drawn does not escape and is not diluted by outside air.

Opposite top section 110, disposed toward the bottom wall of tank 124, is bottom section 140. Bottom section 140 includes bottom section connector 141 which mechanically couples with at least bottom adapter 129 of tank 124 to a personal vaporizer housing, which may contain a system control, display, and power source. Power source may be any suitable power source to provide energy to vaporize the liquid. To facilitate portability, power source may include a rechargeable battery, such as a lithium ion battery or the like. To such ends, housing may also include a port for connecting batteries to a recharging source. For example, the port may include a USB port, mini-USB port or other adapter.

Electrical connection of heating element 127 to the power source may be a wired connection, plug connection or the connection may be created when mounting the tank 120 on the device housing, as shown. For example, bottom section 140 also includes a power connection 146 extending away from the bottom wall of tank 124, such as a 510 pin connection or the like. Power connection 146 is configured to couple with a battery or other electrical power source, and can include one or more electrical contacts to such effect. As depicted in, e.g., FIGS. 1-7, these and other connecting elements are threaded, but it will be appreciated that alternative coupling techniques can be provided without diverging from the scope or spirit of the innovation.

Bottom section 140 also includes bottom inlet 145. Bottom inlet 145 provides fluid communication between air chamber inlet 128, which extends into bottom section 140, and an outside environment thereby permitting airflow through air chamber 123. In embodiments, bottom inlet 145 is adjustable to increase or decrease the amount of the aperture of bottom inlet 145 is open for airflow, thereby providing a mechanism to increase or restrict resistance to airflow. Such embodiments can provide a sliding or rotating element to “open” or “close” bottom inlet 145. In alternative or complementary embodiments, a portion of air chamber inlet 128 and/or bottom section 140 is movable to provide similar function.

System 100 can also include cover 150. Cover 150 can be a decorative cover providing aesthetic elements over at least a portion of tank section 120. Cover 150 can also serve as a structural reinforcement (e.g., to protect and prevent deformation of tank section 120 or other elements) or a thermal insulator (e.g., to prevent heat from heating element 127 from being transmitted to a holder of the device). Cover 150 can slide on or off tank section 120 from at least one direction. In embodiments, cover 150 can include cover coupler 151 which attaches to one or both of bottom section 140 and/or tank section 120. In alternative or complementary embodiments, one or both of top portion and/or bottom portion can retain cover 150 in its position over tank section 120 by blocking its removal when coupled.

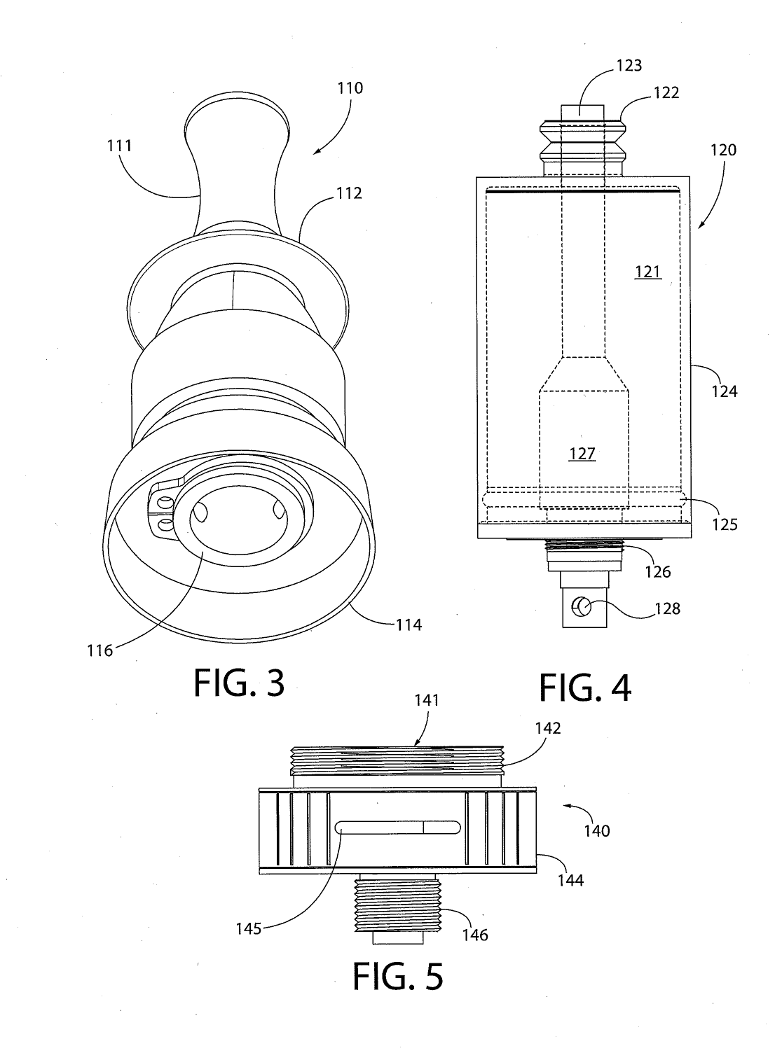

FIGS. 3 to 6E show various portions of system 100 in isolation. Specifically, FIG. 3 shows an example embodiment of top section 110 in greater detail, including mouthpiece 111 and mouthpiece adapter 112. Mouthpiece adapter 112 generally includes a body to which the mouthpiece 111 is attached. It will be understood that it is possible to interchange or occasionally remove the mouthpiece 111 from mouthpiece adapter 112. To that end, a mouthpiece coupler 114 may be used to selectively attach the mouthpiece 111 to the body. Mouthpiece coupler 114 may be any suitable connector including for example the snap ring shown in FIG. 3. Mouthpiece adapter 112 may further include a coupling ring 115 at one end, which can contact tank section 120 when coupled, and air conduit 116 in fluid communication with air chamber 123. In the example shown, coupling ring 115 has a skirt-like form with a peripheral wall that extends downward from body and beyond the end of the mouthpiece to overly a portion of the tank section 120. While aspects herein can be described as “rings” or in terms of circular geometry, it is understood that other shapes and cross-sections (e.g., rectangular shapes or others) can be employed without departing from the scope or spirit of the innovation.

FIG. 4 shows tank section 120 in closer detail. In embodiments, tank section 120 may include tank 124 which is transparent, allowing the user to view the fluid level therein with an outer protective shell that at least partially covers a transparent tank. In the example shown, tank 124 can be constructed of glass and the shell includes a metal cover that encloses a portion of the tank while leaving a portion of the glass exposed for viewing of the tank contents.

FIG. 5 shows bottom section 140 in greater detail including the female bottom section connector 141, the male bottom outer connector 142, bottom body 144, bottom inlet 145, and power connection 146. In an embodiment similar to one discussed above, body 144 is rotatable and includes bottom inlet 145 (e.g., a slot, hole, aperture) that corresponds to an interior slot such that rotation of the outer ring selectively expands or contracts the opening of the inner slot to allow more air to be drawn into the system. The power connector 146 is shown in more detail in FIG. 5, may include a threaded connection and contact tip to engage a corresponding internally threaded receiver on the device housing to provide a secure electrical connection.

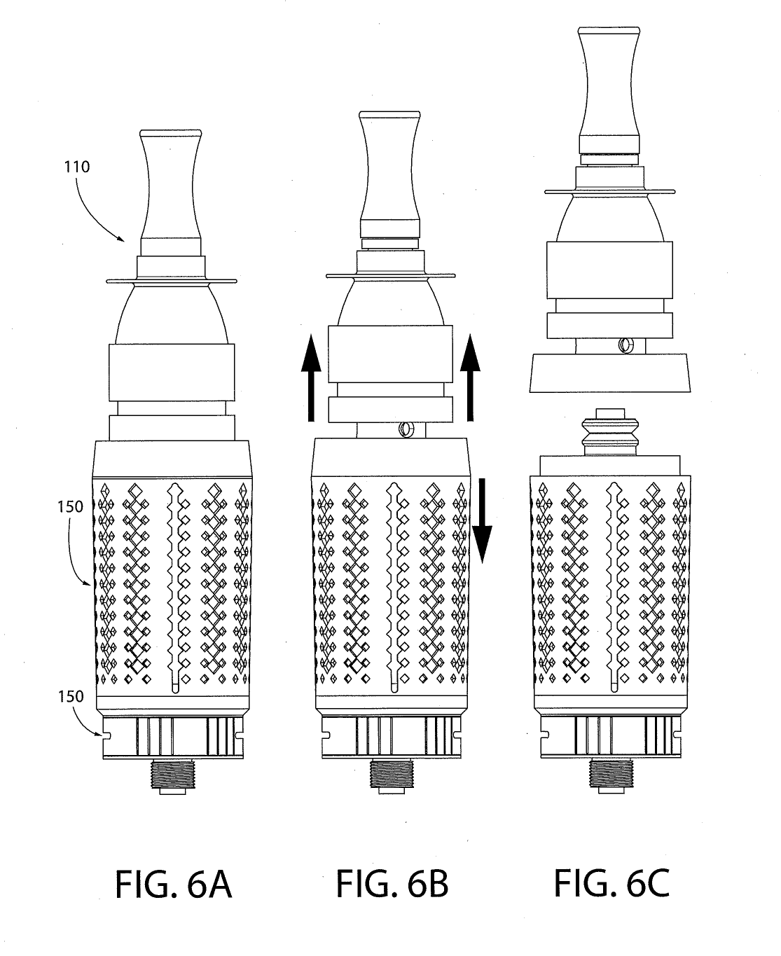

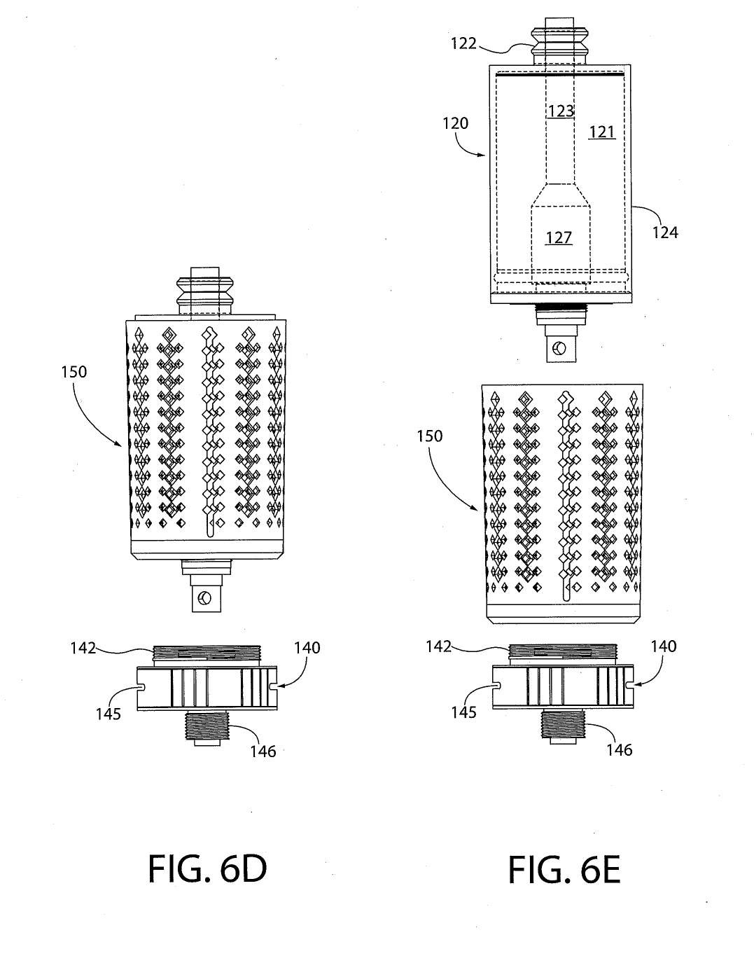

FIGS. 6A-6E show details of a coupling system according to aspects of the innovation. In general, mouthpiece adaptor 112 may be selectively connected to tank section as discussed above. The coupling system may include any suitable connection including clips, snaps, threaded connections, bayonet connections, quick connections and the like. In an example, coupling system includes a detent assembly that includes a movable detent (see, e.g., FIG. 2) that selectively moves radially to engage a connector extending upward from tank section 120. The connector extending upward from the tank section 120 can be a generally cylindrical protrusion that is sized to be received within the bore of mouthpiece adapter 112. The protrusion includes an annular channel or other receiver that accepts the detent to connect the mouthpiece adaptor to the tank section 120. In this example, detent can be a ball bearing mounted within the bore of mouthpiece adaptor 112. The ball bearing is driven radially outward by the protrusion as it is inserted into the bore, and permitted to move radially inward when aligned with the annular recess. The bearing is biased inward and is received within the recess to connect mouthpiece adaptor 112 and tank section 120 (embodiments depicted in, e.g., FIGS. 2 and 6A). An outer sleeve of mouthpiece adaptor 112 can be used to hold the ball bearing in the connected position by preventing radial outward movement thereof.

As shown in FIG. 6B, selective release of the mouthpiece adaptor is accomplished by sliding the sleeve upward to remove the positive stop on the ball bearing and allow it to retract, e.g., move radially outward as tank section 120 is moved axially outward (down arrow) from mouthpiece adaptor 112. FIG. 6C shows the mouthpiece adaptor and tank section 120 in a released condition. FIGS. 6D and 6E depict disassembly of tank section 120. As shown, the tank 124 may be removed from an assembly that includes decorative cover 150 and bottom section 140. It will be understood that this provides the user with the ability to interchange tanks while retaining a common decorative element, or change decorative elements as desired. The particular decorative outer cover shown is not limiting.

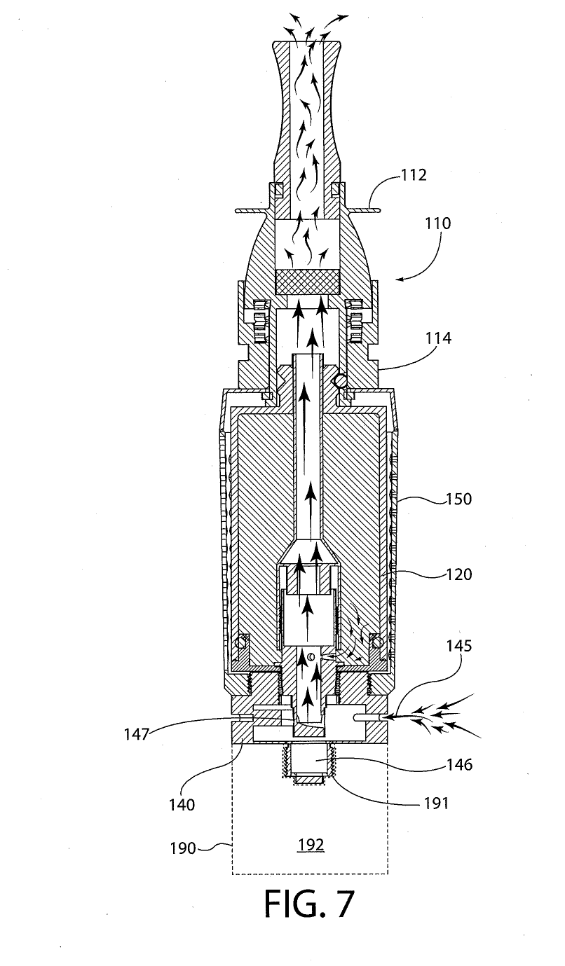

FIG. 7 provides a further view of an example system 100 in operation with optional battery section 190. Battery section 190 couples with bottom section 140. Battery section 190 can, but need not, include battery coupler 191, which mates with power connection 146, and battery 192 which contains cells for powering system 100.

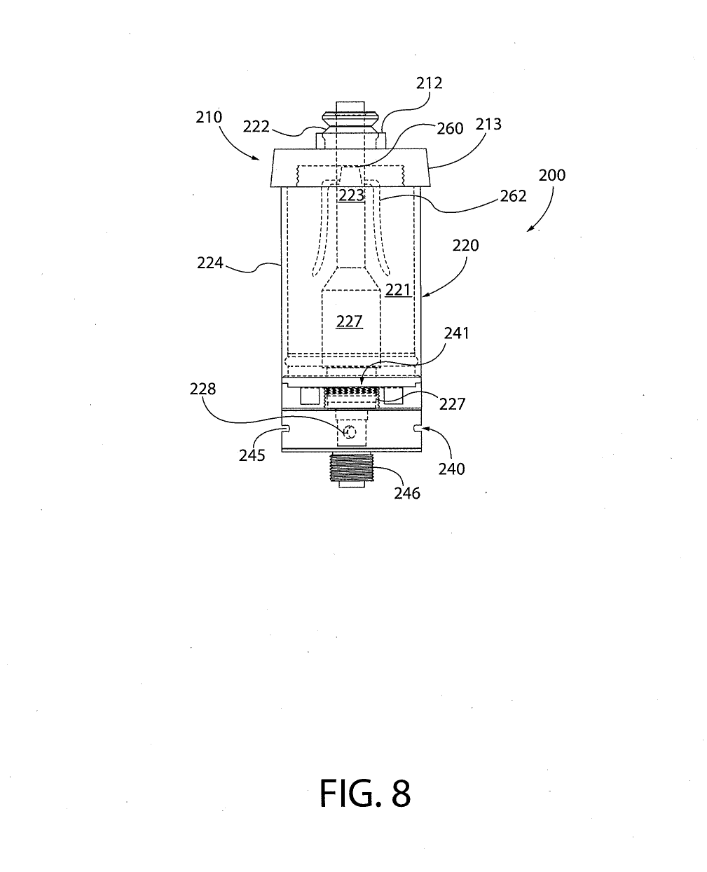

FIG. 8 depicts an alternative embodiment of a system 200 including a tank section 220 including a consumable fluid. System 200 includes top section 210 having mouthpiece adapter 212 and top section coupler 213, and bottom section 240 having bottom section connector 241, bottom outer connector 242, and power connection 246. Bottom section 240 also includes bottom inlet 245. Tank section 220 can include vapor interface 222, air chamber 223, tank 224, 26, and heating element 227.

Additional elements can be included in various embodiments of systems disclosed herein. As shown in, e.g., FIG. 8, system 200 can include wick 262, which can be retained by wick cap 260. Wick 262 can be in fluid communication with consumable fluid reservoir 221 and any fluid(s) therein. Wick 262 can also be in thermal communication with heating element 227.

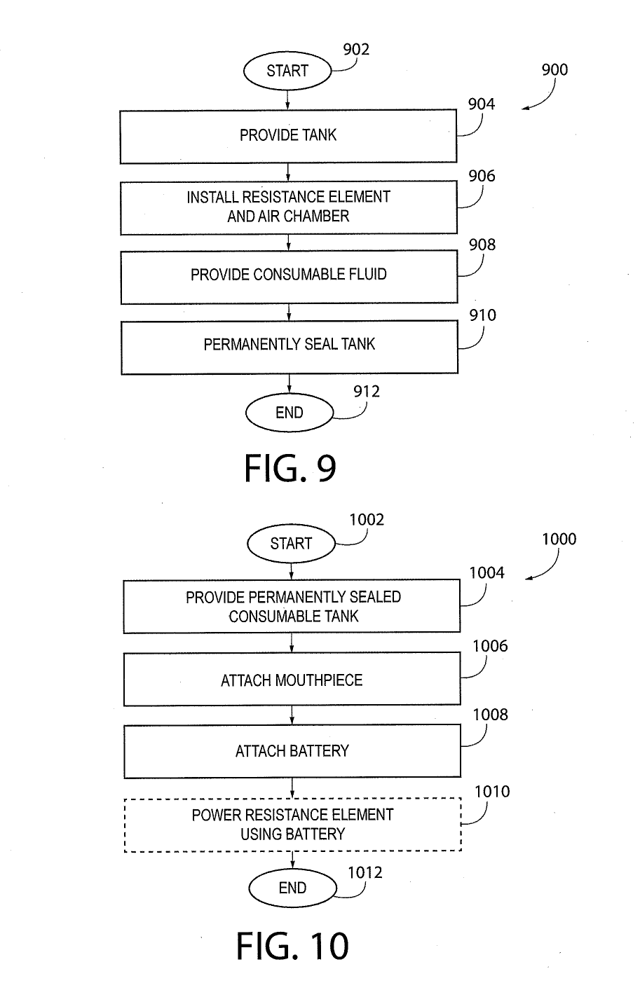

FIGS. 9 and 10 illustrate example methodologies for making and using systems and components such as those described. While particular orders and arrangements are show in the example flow charts provided, it will be appreciated that the order and arrangement may vary without departing from the scope or spirit of the innovation.

FIG. 9 particularly shows an example block diagram of a methodology 900 for making a tank containing a consumable for vaporization. Methodology 900 begins at 902 and proceeds to 904 where a tank is provided. The tank can have at least one outer side wall, and a bottom wall. The tank can include at least a consumable fluid reservoir adapted to receive at least a consumable fluid, and the bottom wall can include an electrical interface. At 906 methodology 900 includes installing at least a heating element and an air chamber through at least a portion of the consumable fluid reservoir. The heating element is in electrical communication with the electrical interface. At 908, at least one consumable fluid is provided in the consumable fluid reservoir. Thereafter, at 910, methodology 900 includes installing a top wall to permanently seal the tank, the top wall having a vapor interface for fluid communication with the air chamber. Once permanently sealed, methodology 900 proceeds to terminate at 912.

Variants of methodology 900 can also include installing a mouthpiece adapter in fluid communication with the vapor interface. In embodiments, the tank of methodology 900 is configured to removably couple with a top tank ring in fluid communication with the vapor interface. In further such embodiments, the methodology can include installing an interchangeable filter between the vapor interface and the top tank ring. In alternative or complementary embodiments, the methodology includes installing a power connection in electrical communication with the electrical interface. In further such embodiments, the tank can be configured to removably couple with a bottom tank ring in electrical communication with the electrical interface. Further alternative or complementary embodiments can include installing a wick in fluid communication with the at least one consumable fluid and/or installing an interchangeable cover around the at least one outer side wall.

FIG. 10 illustrates an example block diagram of a methodology 1000 for using a tank containing a consumable for vaporization. Methodology 1000 begins at 1002 and proceeds to 1004 where a tank containing a consumable is provided. The tank can have at least one outer side wall, a bottom wall, and a top wall, and further include at least a consumable fluid reservoir containing a consumable fluid. The tank can also include an air chamber through at least a portion of the consumable fluid reservoir and in fluid communication with a vapor interface of the top wall. Also, the tank can include a heating element through at least a portion of the consumable fluid reservoir and in electrical communication with an electrical interface of the bottom wall. At 1006, methodology 1000 can include attaching a mouthpiece in fluid communication with the vapor interface, and thereafter at 1008, can include attaching a battery in electrical communication with the electrical interface. Optionally, methodology 1000 can further include providing power to the heating element from the battery. At 1012, methodology 1000 terminates.

In further embodiments, methodology 1000 can also include attaching an interchangeable cover around at least a portion of the at least one outer side wall. In alternative or complementary embodiments, the methodology can include providing an interchangeable filter between the vapor interface and the mouthpiece.

In the specification and claims, reference is made to a number of terms described hereafter. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may,” “may be,” “can,” and/or “can be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

To the extent that the term “includes” is used in either the detailed description or the claims, such term is intended to be inclusive in a manner similar to the term “comprising” as “comprising” is interpreted when employed as a transitional word in a claim.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A system, comprising:
a tank, the tank having at least one outer side wall, a top wall, and a bottom wall;
a consumable fluid reservoir of the tank adapted to receive at least a consumable fluid;
a heating element of the tank extending through at least a portion of the consumable fluid reservoir;
an air chamber of the tank extending through at least a portion of the consumable fluid reservoir;
a mouthpiece adapter extending away from the top wall of the tank, the mouthpiece adapter in fluid communication with the air chamber and configured to couple with a mouthpiece for drawing fluid from the air chamber; and
a power connection extending away from the bottom wall of the tank, the power connection in electrical communication with at least the heating element and configured to couple with a battery.

2. The system of claim 1, further comprising a bottom section configured to removably couple with the tank over the bottom wall, the power connection extending from the bottom section.

3. The system of claim 2, further comprising an adjustable bottom inlet of the bottom section in fluid communication with the air chamber.

4. The system of claim 1, further comprising a top section configured to removably couple with the tank over the top wall, the mouthpiece adapter extending from the top section.

5. The system of claim 4, further comprising an interchangeable filter between the air chamber and at least a portion of the mouthpiece adapter.

6. The system of claim 1, further comprising a wick of the tank in fluid communication with the consumable fluid reservoir.

7. The system of claim 1, further comprising an interchangeable cover configured to surround at least a portion of the at least one outer side wall.

8. The system of claim 7, further comprising:
a bottom section configured to removably couple with the tank over the bottom wall; and
a top section configured to removably couple with the tank over the top wall,
the interchangeable cover is retained about the at least one outer side wall through contact with at least one of the bottom section and the top section.

9. A method of making a disposable consumable container for a vaporizing device, comprising:
providing a tank, the tank having at least one outer side wall, and a bottom wall, the tank including at least a consumable fluid reservoir adapted to receive at least one consumable fluid, the bottom wall having an electrical interface;
installing at least a heating element and an air chamber through at least a portion of the consumable fluid reservoir, the heating element in electrical communication with the electrical interface;
providing the at least one consumable fluid in the consumable fluid reservoir; and
installing a top wall to permanently seal the tank, the top wall having a vapor interface for fluid communication with the air chamber.

10. The method of claim 9, further comprising installing a mouthpiece adapter in fluid communication with the vapor interface.

11. The method of claim 10, the tank configured to removably couple with a top tank ring in fluid communication with the vapor interface.

12. The method of claim 11, further comprising installing an interchangeable filter between the vapor interface and the top tank ring.

13. The method of claim 9, further comprising installing a power connection in electrical communication with the electrical interface.

14. The method of claim 13, the tank configured to removably couple with a bottom tank ring in electrical communication with the electrical interface.

15. The method of claim 9, further comprising installing a wick in fluid communication with the at least one consumable fluid.

16. The method of claim 9, further comprising installing an interchangeable cover around the at least one outer side wall.

17. A method of using a vaporizing device, comprising:
providing a tank,
the tank having at least one outer side wall, a bottom wall, and a top wall,
the tank including at least a consumable fluid reservoir containing a consumable fluid,
the tank including an air chamber through at least a portion of the consumable fluid reservoir and in fluid communication with a vapor interface of the top wall, and
the tank including a heating element through at least a portion of the consumable fluid reservoir and in electrical communication with an electrical interface of the bottom wall;
attaching a mouthpiece in fluid communication with the vapor interface; and
attaching a battery in electrical communication with the electrical interface.

18. Method of claim 17, further comprising providing power to the heating element from the battery.

19. Method of claim 17, further comprising attaching an interchangeable cover around at least a portion of the at least one outer side wall.

20. Method of claim 17, further comprising providing an interchangeable filter between the vapor interface and the mouthpiece.
